(19) United States
(12) Patent Application Publication
(10) Pub. No.: US 2026/0195807 A1
(43) Pub. Date: Jul. 9, 2026

(54) SYSTEMS AND METHODS FOR PROVIDING PERSONALIZED NUDGES IN A COMPETITION ENVIRONMENT

(71) Applicant: WELLS FARGO BANK, N.A., San Francisco, CA (US)

(72) Inventors: Srimugunthan Dhandapani, Bangalore (IN); Raghu Shyam Sivasundaram, Bangalore (IN); Siddartha Kandikonda, Bangalore (IN)

(21) Appl. No.: 19/009,862

(22) Filed: Jan. 3, 2025

(51) Int. Cl. G06Q 40/02

(52) U.S. Cl. CPC G06Q 40/02

(57) ABSTRACT

Systems and methods for providing nudges including displaying contests; receiving a selection of a contest by a user; receiving a user profile associated with the user; identifying a comparison set associated with the selected contest based on the user profile exceeding a threshold similarity when compared to a set of user profiles; categorizing one or more user transactions and, for each of the one or more user transactions, tracking a user performance metric associated with the user transaction; categorizing one or more comparison transactions by the comparison set, and for each of the one or more comparison transactions, tracking a comparison performance metric associated with the comparison transaction; determining an insight by determining one or more of the user performance metrics exceeds, by a negative threshold, a corresponding comparison performance metric and by identifying a corrective action; and displaying an alert associated with the insight.

### FIELD OF INVENTION

The present disclosure generally relates to a system for providing insight to users, and more particularly to systems and methods for providing personalized insights in a competition environment.

### BACKGROUND

Lack of motivation and insight into users'financial habits can prevent users from achieving goals such as managing budgets, reaching milestones, and maintaining focus on desired outcomes. Often times, users trying to manage their budgets are driven by impulsive spending, preventing them from reaching their goals. This issue is exacerbated by the fact that different users may have different impulses, behaviors, and motivations. Specific tips on how to achieve a desired outcome may be more effective on one user compared to another user. Varying demographics amongst users may also make it hard to extrapolate the most effective means of motivating a given user.

Traditional systems and applications for financial management lack interfaces that are tailored to specific users, capable of motivating each user individually in ways more effective than generalized tips and recommendations pushed from the financial management institution or service. Moreover, such systems and applications do not provide effective motivation to users. Rather, such systems and applications rely on the user to be self-motivated to achieve their goals. Thus, there is a need for more intelligent systems capable of providing insights to users that are more effective than current systems and applications, additionally, there is a need to systems more effective in motivating users to achieve their goals.

### SUMMARY

According to certain embodiments, a system for providing personalized nudges includes one or more processors configured to: display one or more contests; receive, from a user, a selection of a contest of the one or more contests; receive a user profile associated with the user; identify a comparison set associated with the selected contest based on the user profile exceeding a threshold similarity when compared to a set of user profiles associated with the comparison set; categorize one or more user transactions and, for each of the one or more user transactions, tracking a user performance metric associated with the user transaction; categorize one or more comparison transactions by the comparison set, and for each of the one or more comparison transactions, tracking a comparison performance metric associated with the comparison transaction; determine an insight through steps comprising: determining one or more of the user performance metrics exceeds, by a negative threshold, a corresponding comparison performance metric; identifying a corrective action based on corresponding comparison performance metric; and display an alert associated with the insight to the user.

Another embodiment relates to a method that includes displaying one or more contests; receiving, from a user, a selection of a contest of the one or more contests; receiving a user profile associated with the user; identifying a comparison set associated with the selected contest based on the user profile exceeding a threshold similarity when compared to a set of user profiles associated with the comparison set; categorizing one or more user transactions and, for each of the one or more user transactions, tracking a user performance metric associated with the user transaction; categorizing one or more comparison transactions by the comparison set, and for each of the one or more comparison transactions, tracking a comparison performance metric associated with the comparison transaction; determining an insight through steps comprising: determining one or more of the user performance metrics exceeds, by a negative threshold, a corresponding comparison performance metric; identifying a corrective action based on corresponding comparison performance metric; and displaying an alert associated with the insight.

A further embodiment relates to a computer-readable storage device that stores executable instructions that, in response to execution by a processor, cause the processor to perform operations including displaying one or more contests; receiving, from a user, a selection of a contest of the one or more contests; receiving a user profile associated with the user; identifying a comparison set associated with the selected contest based on the user profile exceeding a threshold similarity when compared to a set of user profiles associated with the comparison set; categorizing one or more user transactions and, for each of the one or more user transactions, tracking a user performance metric associated with the user transaction; categorizing one or more comparison transactions by the comparison set, and for each of the one or more comparison transactions, tracking a comparison performance metric associated with the comparison transaction; determining an insight through steps comprising: determining one or more of the user performance metrics exceeds, by a negative threshold, a corresponding comparison performance metric; identifying a corrective action based on corresponding comparison performance metric; and displaying an alert associated with the insight.

These illustrative aspects and features are mentioned not to limit or define the presently described subject matter, but to provide examples to aid understanding of the concepts described in this application. Other aspects, advantages, and features of the presently described subject matter will become apparent after review of the entire application.

### BRIEF DESCRIPTION

A full and enabling disclosure is set forth more particularly in the remainder of the specification. The specification makes reference to the following appended figures.

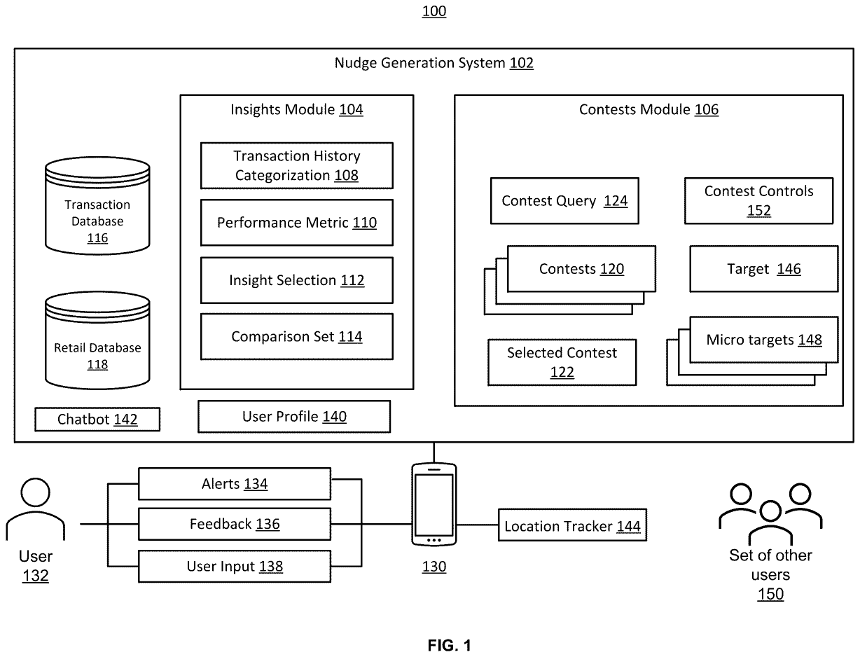

FIG. 1 illustrates an example of a nudge generation system capable of generating insights based on user actions and transmitting the insights as an alert to the user according to certain examples.

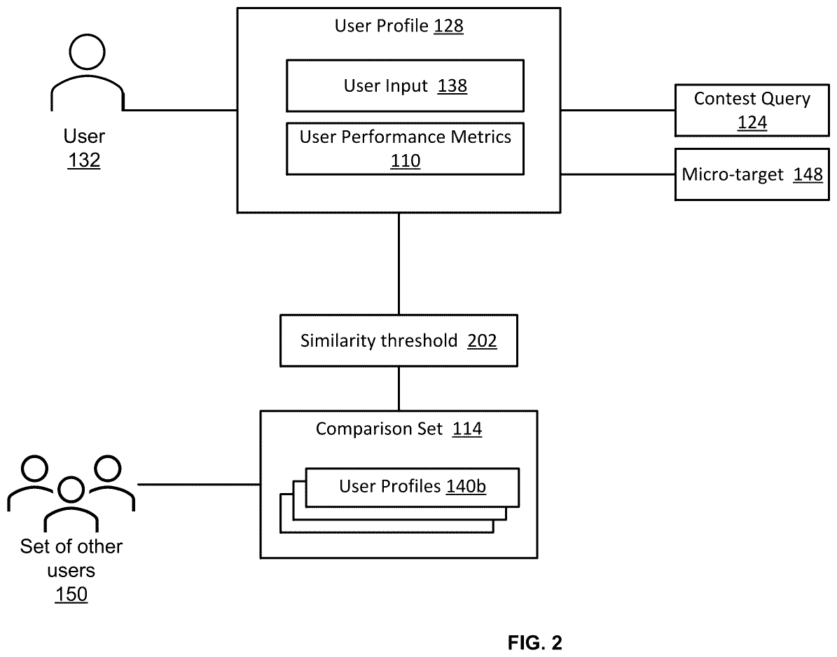

FIG. 2 illustrates example contents of a user profile, the user profile used to determine insights according to certain examples.

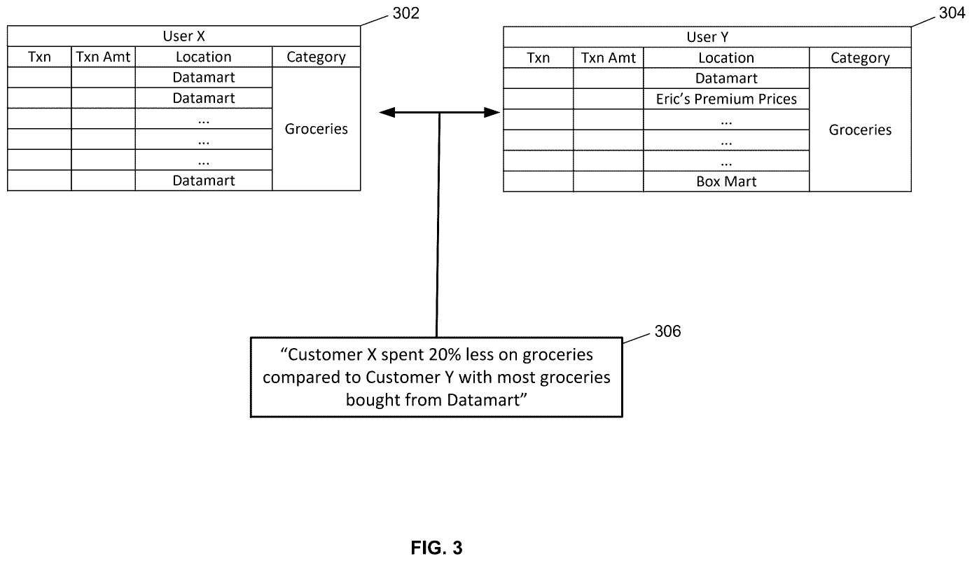

FIG. 3 illustrates an example of an insight determined by evaluating a comparison set according to certain examples.

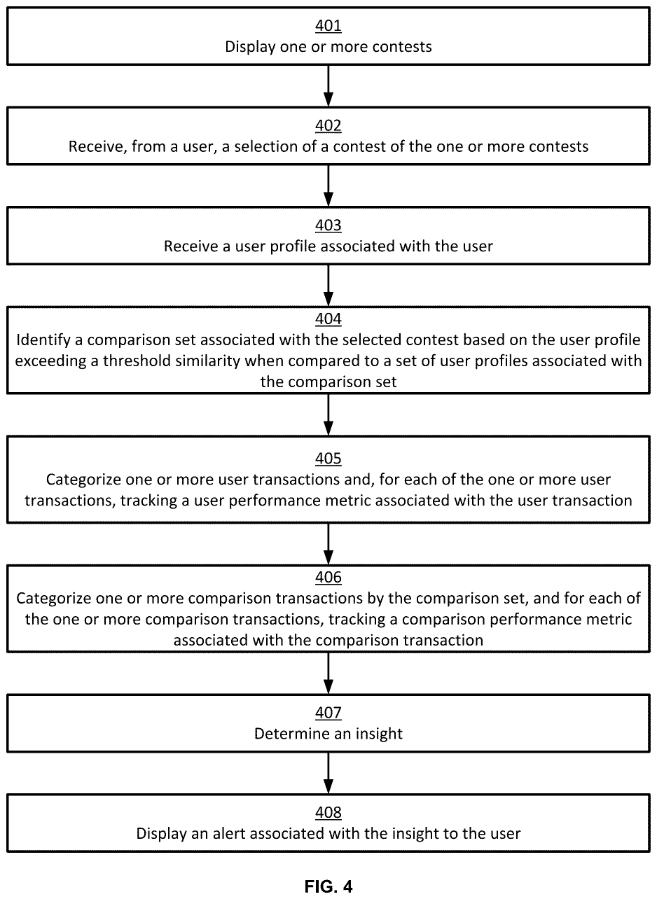

FIG. 4 illustrates an example method of displaying nudges to users, the nudges comprising an insight presented in the form of an alert, according to certain examples.

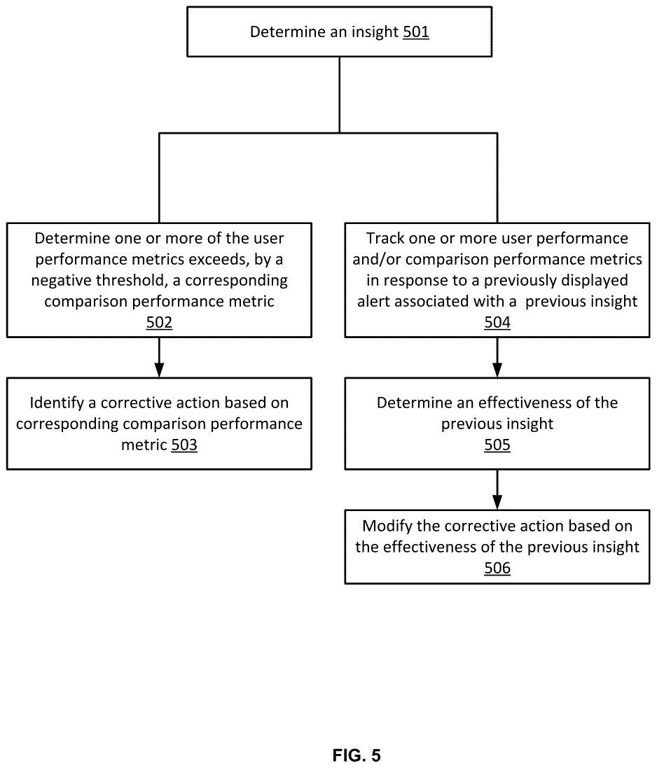

FIG. 5 illustrates example methods of determining insights to present to users in the form of alerts according to certain examples.

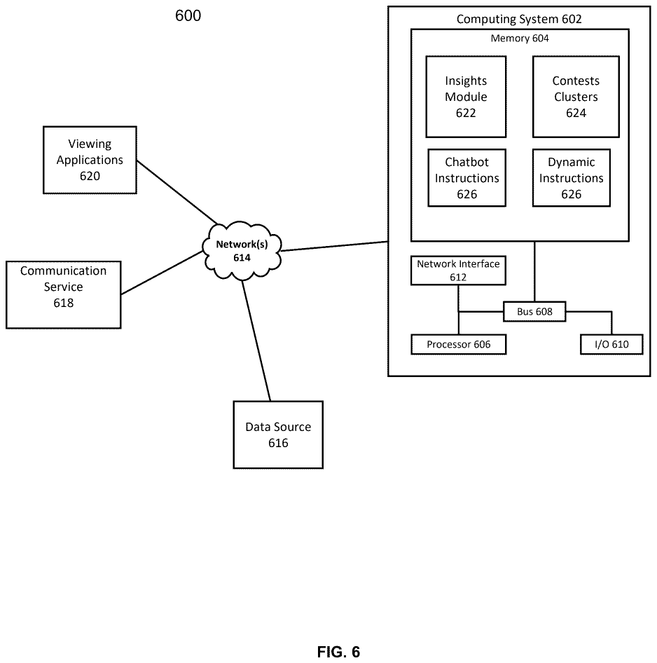

FIG. 6 illustrates a block diagram for an example computing environment capable of executing the described systems and methods, according to certain examples.

### DETAILED DESCRIPTION

Reference will now be made in detail to various and alternative illustrative examples and to the accompanying drawings. Each example is provided by way of explanation, and not as a limitation. It will be apparent to those skilled in the art that modifications and variations can be made. For instance, features illustrated or described as part of one example may be used on another example to yield a still further example. Thus, it is intended that this disclosure include modifications and variations as come within the scope of the appended claims and their equivalents.

### Illustrative Example of a System Providing Personalized Insights in a Competition Environment

In an illustrative example, a system for providing personalized nudges, or insights, within a gamified environment is described. The nudge system can be a software application for download and integration within a personal device of a user, such as a mobile app, a computer program, a web accessible client, or some combination of such interfaces.

The nudge generation system can include several contests related to various goals. For instance, in one example, a contest can include accumulating a lumpsum amount of $100,000 in 2 years. Another contest can be for users to reduce their spending by 20% over the course of a month. Other contests can be purely competitive based, such as to save the most money relative to income amongst a class of similar identified competitors within a competition pool. The contests can be displayed on a dashboard or other page within a user interface. In response, users with access to the nudge system can decide to participate in one or more of the contests, also referred to as the selected contests. Users can choose to participate in one contest at a time, or multiple contests. Particularly where contests are related to distinct goals, the user can choose to participate in several selected overlapping contests.

After choosing a selected contest, the user may be entered into the contest where their performance is tracked. Performance tracking can include tracking the user's transactions during the contest. Using Natural Language Processing (NLP) and metadata associated with each transaction, the user's transactions can be classified and recorded within a transaction database. Classified transactions may be relevant to a given contest and may be used to determine the user's performance within a selected contest. For instance, if a user selects the contest “decrease mobile order spending by 50% over a 60 day period”, transactions classified as mobile order spending will be calculated into the user performance analysis within the competition. Generally, each transaction by a user may be classified and stored within a transaction database, capable of analysis independent of the contests selected by the user. Once entered into a selected contest, the nudge system may actively generate insights and reports related to the contest through alerts transmitted to the user.

The nudge system, by recording each user's performance (e.g., through categorizing and storing users'transactions and generating performance metrics) can perform analyses of each user's performance by comparing the performance of multiple users. Given a first user competing within a competition, a comparison set of users, referred to as a comparison set, may be identified to generate insights which can be provided to the first user as a nudge. The comparison set of users may be identified by comparing user profiles associated with each user within the contest or within the nudge system more generally. Each user may have a user profile which may include elements such as the user's prior performance within the same or other contests. Additionally or alternatively, user profiles may include elements such as demographic and income information. For instance, in some examples, user profiles may include elements such as the user's household income, household size, debt, and the like.

In the same or other examples, the comparison set of users may be defined as the users competing within the competition who are identified as outperforming a majority of other users within the contest. Users may be assigned user performance metrics within the competition environment, indicative of a percentile within the group. For instance, in a contest to save 50% of discretionary income over the course of six months, the top 2% of users based on saved discretionary income over a given measurement period may be identified as in the 98^{th} percentile. Such users in the 98^{th} percentile or above may be determined to be the comparison set, where the comparison set's performance metrics are compared against those of the first user. The analyses performed are used to generate an actionable insight to be provided to the first user in the form of an alert or nudge. The percentile used to define the comparison set may be adjusted to expand or narrow the size of the comparison set and to fine tune the analyses used to generate actionable insights provided to the first user.

As an example of analysis used to generate an insight, the performance of the comparison set may be analyzed to determine trends in the comparison set's user performance. Transaction histories of the comparison set may be aggregated and classified to identify trends including what actions were performed to lead them to reaching the outperforming percentile. For example, the user performance of the comparison set may indicate that the comparison set, in the aggregate, spent 30% less dining out in comparison to the first user. The nudge system may then generate an insight 112, nudged to the first user through an alert, that indicates to the first user that the first user can improve their performance within the contest by spending less dining out.

The nudge system's interface can comprise nudges in the form of insights provided to users through alerts. For example, the nudge system may generate a nudge to a user's cell phone, alerting the user to an insight generated by the nudge system as described above. The nudge system interface can also include buttons allowing the user to inquire into the nudge system to retrieve insights. Part of the nudge system interface may include a leaderboard, percentile comparator, or the like which indicates to the user their relative user performance in the contests. If the user, seeing their user performance displayed, or alerted by the nudge system of their user performance, wishes to improve their performance, can inquire into the nudge system interface to retrieve insights on how to improve.

In some examples, the nudge system interface includes a language learning model (LLM) based chat model (also referred to as a chatbot) providing means for the user to have a more fluid conversation gathering details related to their performance as well as potential insights related to improving their performance. The chatbot can comprise rule-based hard-coded logic such as decision-trees capable of identifying responses to user inputs and inquiries. The chatbot can also comprise machine learning trained chat models including shallow and/or deep machine learning algorithms trained to parse user input, identify responses, and output responses back to the user, the responses including insights responsive to the user inquiry.

The nudge system can additionally, progressively tailor insights to respond to the performance of a given user competing within the nudge system competition environment. As an example, the insights provided to the user may be logged for comparison against the user's performance following the insight being alerted to the user. Tracking the user's performance in response to having received a given nudge may be used to determine the effectiveness of the previous insights provided as nudges to the user. As an example, a user may be alerted with an insight that indicates to the user that they disproportionately spend 30% more on travel compared to the goal achieving comparison set, the insight further recommending spending less on travel. Subsequent performance metrics monitored by the nudge system may indicate that the user has minimally decreased, or not decreased at all, their travel expenditures. In response, the nudge system may determine the personalized insight relative to that user is ineffective. As a result, the nudge system can further tailor and test different insights, such as providing a new insight indicating to the user that flight ticket prices are lower on a given day. In such a way, the nudge system can continuously learn the financial habits of a user, determine the effectiveness of different insights provided to the user, and tailor future insights adapting to behaviors that comport best with the given user while still motivating the user to achieve financial goals, e.g., through the selected contest.

A similar approach of determining the effectiveness of nudges, and fine tuning those nudges in future insights and alerts provided to users, may be applied across a larger set of users within the competition, and to a global set of users competing within different competitions within the nudge competition environment. Insights provided to a set of users of users, including all users within a contest, or all users across all contests, may be recorded along with the set's subsequent performance metrics to determine the effectiveness of a specific insight. Minimal effectiveness gauged by the set's performance metrics being minimally affected by the insight may cause the nudge system to reduce the weight of the insight being generated as a nudge in future instances. As above, if the nudge is determined to be particularly effective to a certain user, such nudges may be maintained or bolstered for that corresponding user despite the larger set's general non-reactance to the nudge. However, generally, when a user is first initiated into the nudge system and enters the first contest, the nudge system will have minimal information within the user's profile and about their corresponding performance in relation to particular nudges. As a result, the nudge system may generate initial nudges based on an insight's effectiveness relative to a larger set or a global set of users'performance metrics, and then progressively increase the weight of nudges tailored to the user based on the determined effectiveness of previous insights relative to that user.

In addition to generating insights and alerts by evaluating the transaction history of a user or a set of users, the nudge generation system can also generate nudges by evaluating a retail database. The retail database may include data retrieved from a variety of sources including restaurant databases (e.g., a database tied to one restaurant, or a database aggregating restaurant data from a variety of databases), grocery store databases (similarly related to a single grocer or an aggregate database monitoring grocer prices, sales, and discounts), department store databases and the like. The retail database can include data such as ongoing discounts at various online stores as well as brick and mortar stores located close to a given user. The nudge generation system can then generate insights alerted to users indicating discounts accessible to the user, where the insights further indicate how the discounts may assist the user in reaching targets and micro-targets or milestones within the competition. According to some examples, the nudge system can generate insights based both on the transaction history data and the retail data set. For instance, the a user's performance metrics, as tracked by the transaction history data, may indicate that the user disproportionately spends periodically on Wednesdays. In response, the nudge system can pull from the retail data set to identify local restaurants providing discounts on Wednesdays. The generated insight provided to the user may then indicate to the user that they disproportionately spend on dining compared to the goal achieving comparison set, and recommend, in a first insight, to reduce spending on dining, and subsequent to determining that insight was ineffective in adjusting the user's performance metrics, generate a second insight recommending to the user to various restaurants providing discounts on Wednesdays.

In providing a competition based interface, the nudge system may also divide each competition into a target, representing the end goal of the competition, subdivided amongst micro-targets, also referred to as milestones or milestone-points. The micro-targets may comprise milestones breaking the target of the competition into intervals provided to the user on a more periodic basis. As an example, competition target may be to save $12,000 over the course of a year. The micro-targets may then comprise monthly targets of saving $1,000 a month, or $500 every two weeks. Nudges and insights may be generated based on the user's performance metrics in relation to the target and/or the micro-target. For instance, if the nudge system detects the user's relevant performance metrics are placing them off track to meet the micro-target, the nudge system may generate an insight providing a recommendation to the user indicating they are off track, and any corrective actions they may take to get back on track toward hitting the micro-target and/or the target of the competition. The micro-targets may similarly adapt to the user's performance metrics. If a user underperforms and fails to meet a micro-target during one period, the nudge system can adjust subsequent micro-targets by raising them, motivating the user to get back on track to reaching the target. Alternatively, the micro-targets and target may be adjusted to reflect a more realistic goal relevant to the user. In some examples, the comparison set of users may be determined based on the users'performance related to hitting the micro-targets. Outperforming users placed in the comparison set may be determined based on hitting a threshold number of micro-targets. From there, the nudge system can determine insights based on the comparison set's performance and determine insights including corrective actions to nudge to the user to help assist the user to similarly reach the target.

In many examples, the insights generated and provided to the user through alerts will include a corrective action or recommendation. The corrective action may recommend to a user how to improve their performance within the selected contest. More generally, the corrective action can include indications on how to save and best practices to help users reach goals. As discussed above, the corrective action may be identified by comparing performance metrics between one user and a comparison set of users, where the comparison set of users is identified based on strong performance within the competition and/or similarity of each user's user profile. In the same or other examples, insights alerted to users as nudges need not include corrective actions and instead can include statements checking in with the user's performance and/or congratulating the user on their performance. Some nudges for instance may congratulate a user for hitting a mini-target within the competition, or for performing at a threshold percentile within the competition. As an example, one nudge provided to a user may congratulate the user for saving more than 90% of other users in a savings based competition each month for the past three months. Another nudge may congratulate a user for reducing discretionary spending related to a particular restaurant or other habit personal to the user.

To reward users for successful completion of a competition or for outperforming others within a competition, the nudge system can assign awards to a user's profile. Generally the awards may comprise non-monetary awards including tokens, insignias, virtual medallions and the like. On an interface of the nudge system, an avatar of the user featuring aspects of the user profile may then present the user's awards from current and prior competitions. In such a way, users competing in the nudge environment may be motivated not only by periodic nudges, but also by non-monetary rewards displayed in relation to the user's profile.

These illustrative examples are given to introduce the reader to the general subject matter discussed here and are not intended to limit the scope of the disclosed concepts. The following sections describe various additional features and examples with reference to the drawings in which like numerals indicate like elements, and directional descriptions are used to describe the illustrative examples but, like the illustrative examples, should not be used to limit the present disclosure.

### Example System for Providing Personalized Insights in a Competition Environment

FIG. 1 illustrates an example of a nudge generation system capable of generating insights based on user actions and transmitting the insights as an alert to the user according to certain examples. The nudge generation system 102 includes an insights module 104 capable of generating insights delivered to users as alerts 134. The nudge generation system 102 also includes a contests module 106 that can retrieve contests for display and selection by each of the users with access to the nudge generation system 102.

The contests module 106 can retrieve a plurality of contests 120 for selection by a user 132. The contests 120, also referred to as games, include various challenges related to financial performance, wherein users entering within the contest (e.g., by selection of the contest) may have their performance tracked and compared amongst other users 150. Examples of contests include reducing discretionary spending by 5% per month over the course of six months or saving 10,000$ over the course a year. Contests 120 may be time bounded (e.g., saving a threshold amount of dollars over the course of a time period) or target bounded (e.g., reaching a threshold amount of savings in a bank account, regardless of time taken), or some combination of the two. Contests 120 will generally include a target 146 to be achieved by the end of the duration of the contest, or which ends the contest. Examples of targets 146 include satisfying one or more performance metrics 110 such as a percentage reduction in spending in a given category, or a target accumulation of savings in a given account. Targets 146 may also be divided into micro-targets 148, also referred to as milestones or milestone points. Micro-targets 148 may provide for intermediate reports of user performance during the duration of contest. Continuous deployment of micro-targets 148 may be applied to incentivize the user 132 towards reaching the target 146. In some examples, micro-targets 148 may be adaptive to user performance. For instance, failure to meet a micro-target 148 may cause a subsequent micro-target 148 to be adjusted upwards to motivate a user 132 or may be adjusted downwards to provide a more attainable goal to the user 132.

The contests 120 may be displayed to the user 132 through an interface 130 so that the user can determine a selected contest 122 for the user to compete in. The contests 120 displayed to the user 132, from a larger contest set, may be determined through a contest query 124. The contest query 124 can determine the most relevant contests to a user 132 based on the user's user profile 140 and the user's performance within previous contests. Additionally or alternatively, the contest query 124 can determine contests to display to the user 132 through the interface 130 based on global performance within the given contest. For instance, the contest query 124 can identify contests with lower rates of achievement (e.g., of the users who competed in a prior instance of the contest, only 30% achieved the target compared to 70% achieving targets in other contests). The contest query 124 can then match contests based on historical difficulty to users and/or provide a display to users identifying contests by a range of difficulty. In one example, the contest query 124 determines that a user 132 has historically overperformed in prior contests, and in response, causes the interface 130 to display more challenging contests for the user to further adapt to the user's relative proficiency in the competitive environment.

Having displayed a range of contests, or having recommended contests to the user 132, the user, through the user interface 130, can select one or more contests to compete in. Upon selection, the user may be entered into the selected contests 122, where the user's performance is monitored relative to the performance of a comparison set of users 150.

The comparison set 114 may be determined based on the one or more users 150 comprising the comparison set 114 set having achieved a threshold level of success within the selected contest 122. Threshold levels of success may be determined by the rate at which a user reaches micro-targets 148 within the contest, based on the user's performance metrics 110, or a weighted combination of the two. For instance, a user's performance metrics 110 may indicate that the user has reduced spending on private transit services at a rate greater than 90% of other users in a contest related to reducing discretionary spending. As a result, the insights module 104 may place the user in the comparison set for comparison against other users who have not achieved the same rates of success.

The comparison set 114 may also include a group of one or more users who may share a threshold similarity of characteristics to a given user 132. In evaluating the threshold similarity between users to determine the comparison set 114, the insights module can evaluate user profiles 140 associated with each user. The user profiles 140, further described with respect to FIG. 2, can include demographic and other identifying information provided by users. The evaluation may comprise comparing the user profiles associated with one user 132 and one or more other users 150. For each of the one or more other users with similarity score greater than a threshold similarity, such user may be placed in the comparison set for subsequent comparison against the first user. In such a manner, users with similar financial goals may be pooled into a single group.

The insights module 104 stores instructions causing the nudge generation system 102 to identify insights that can be displayed to a user 132 through an alert 134 provided via an interface 130. The delivery of the insights through an alert 134 may also be referred to as a nudge, where the nudge provides the insight and motivations to a user 132 to reach target goals as identified within the contest environment. The insights module 104 can determine insights to nudge to the user 132 by aid of a transaction database 116 which stores the transactions of the user 132 in addition to the transactions of other users 150 with access to the nudge generation system 102. The transactions of each user including user 132 may be retrieved from the transaction database 116 and categorized by a transaction history categorization module 108. The transaction history categorization module 108 may rely on NLP techniques including shallow and deep learning algorithms trained to classify transactions for each user. For instance, the transaction history categorization module 108 can classify transactions by each user as related to rent, loans, groceries, dining, travel, leisure, and the like. Transactions can be further classified for greater precision (e.g., by classifying the restaurant purchased from, the time and date purchased at).

Performance metrics 110 may then be generated based on the categorized transactions associated with each user and/or the user's relative performance with respect to a contest. Performance metrics 110 can include statistical data generated from the categorized transactions such as percentage changes in a given category of transaction and additional metadata such as average time and location that a transaction is made. One example of a performance metric can be the percentage decrease in online retail purchases made by the user, or a percentage decrease with respect to a particular vendor. Performance metrics 110 may also represent the net expenditures of the user in a given category of transactions, such as the total classified as having been spent on groceries. Performance metrics 110 may additionally relate to the target 146 and micro-targets of the selected contest 122.

In addition to having access to a transaction database 116, the nudge generation system 102 may also access a retail database 118. The retail database 118 can store date such as retailer location, websites, products, prices, sales and the like. Additionally, the retail database 118 may be augmented by web scrapers and agents configured to monitor data from retailers'websites to ensure data stored within the retail database (e.g., discounts and sales) remains up to date when further evaluated by the nudge generation system 102. By providing the insights module 104 with access to up to date pricing, the insights module 104 can further identify candidate insights to alert to the user. Particularly in cases where the insights module 104, based on the user's prior performance metrics 110, determines that the user 132 did not react to previous insights to purchase less of a good or service, or where the user 132 is reactive to insights indicating discounts, the insights module 104 may provide insights to the user identifying discounts and sales that the user can apply and how purchasing through such discounts and sales may assist the user in reaching a target 146 or micro-target 148.

The user 132 may interact with the nudge generation system 102 through an interface 130. The interface 130 can be an electronic device capable of displaying the nudge generation system 102 such as a phone, mobile device, computer, or the like. In one example, the interface 130 may comprise a static interface that receives nudges comprising insights from the nudge generation system 102 and outputs them as alerts 134 to the user 132. In other examples, the interface 130 may be augmented by a chatbot 142 operating within the nudge generation system 102 and outputting through the interface 130. The chatbot 142 can apply natural language processing and machine learning techniques to receive user input 138 in the form of text based inquiries, compute responses, and provide the responses back to the user 132. The algorithmic structure of the chatbot 142 may comprise hard coded logic, shallow machine learning models, and/or trained neural nets. Machine learning model based chatbots 142 such as a trained neural network may be trained on previous insights, feedback, performance metrics, and may be modified via retrieval augmentation generation (RAG) or other suitable techniques.

The user 132 may also provide feedback 136 through the interface 130 to further personalize the insights delivered and provided by the nudge generation system 102. In an example, feedback may comprise a binary review where the user 132 is prompted to classify a given insight as helpful or unhelpful. In other examples, such as by aid of the chatbot 142, the user can provide more nuanced feedback describing why the insight is helpful or unhelpful. Feedback 136 may also be determined implicitly based on the user's performance in response to having received an insight. For instance, if performance metrics related to a specific insight remain unaffected after the insight is alerted to the user, the nudge generation system 102 may interpret the non-reactance as negative feedback regarding the insight. Future insight determination may then weigh the feedback 136 for each insight in determining which insights to provide to the user in the future. In such a way, the insights nudged to the user may become progressively more personalized over the course of the selected contest and over the course of future contests.

In some examples, for instance where the interface 130 providing the nudge generation system is a mobile device, the nudge generation system 102 can include a location tracker 144. The location tracker 144 may be used to track the location of the user 132 to provide additional information during the transaction history categorization (e.g., location of purchase), which may then be further used to determine performance metrics 110, (e.g., the user 132 is determined to spend an abnormal amount on dining at particular locations). In such a way, the insights module 104 can learn how users spend money based on locational behavior, and tailor insights delivered to the users accordingly. The location tracker 144 may also be paired with the retail database 118 to support further insight generation by the insights module 104. For example, the retail database 118 may identify particular stores or restaurants with ongoing deals that are adjacent to the user 132. Insights may then be further tailored to recommend the user makes transactions at the retails with provided discounts as opposed to other locations. Particularly in instances where the user's performance metrics indicate that the user is not receptive to insights suggesting to not make a purchase, but that the user 132 is receptive to purchasing at other locations, the location tracker 144 paired to the retail database 118 may provide further means to determine effective insights personalized to help a user 132 reach the contest target 146.

In some examples, the contests modules 106 of the nudge generation system 102 may further include a controls module 152. Controls module 152 comprises executable logic capable of monitoring the performance of users 132, 150 within the one or more contests 120 for fraudulent activity. The controls may be tied to the transaction history 108 and/or the performance metrics 110 of the user. For example, threshold cash flows or threshold rates of change in cash flows can be applied, wherein user transactions exceeding the threshold cash flow or threshold rates of change in cash flow may be flagged as fraudulent or suspect fraudulent users. Cash flows may be defined to be based on a specific user credit card, or aggregate checking account of the user. Additionally or alternatively, controls may also include monitoring the activity rate of the users in the contest to determine level of engagement. Users with very low engagement (e.g., under a threshold engagement level) may be flagged as inactive and removed from the contest. In other examples, rapid rates of change between minimal engagement to high engagement may serve as indicia of fraudulent activity which can be weighed against other factors (e.g., the threshold cash flow) for the control module 106 to make a determination on the user's authenticity or fraudulence of a given activity.

Once the contests control module 152 detects a user as having engaged in fraudulent activities, the controls module 152 can execute one or more corrective actions. Examples of corrective actions can include issuing alerts to the user providing a warning of suspected fraudulent activity, removing the fraudulent user from the contest, quarantining the fraudulent user's performance metrics from the contest, assigning the fraudulent user a probationary period, or fully banning the user from future contests.

### Example Contents of a User Profile

FIG. 2 illustrates example contents of a user profile, the user profile used to determine insights according to certain examples. The user profile 128 includes data such as demographic and financial data related to a user, including for, instance, the user's salary, credit, score their education, family size, and the like. The user profile data may be gathered by user input 138. For instance, on a first launch of the nudge generation system interface, users may be prompted to enter information such as the user's household income, household size, user's current debts, and the like. In other examples, demographic information forming the user profile 140 may be retrieved from other databases, without requiring additional input by the user 132. Behavioral data, including the user's historic performance across other contests may also be considered within the user profile 140. Behavioral data may be gathered by the user input 138, external database, and/or by tracking the user's performance and performance metrics 110 as described with respect to FIG. 1. For instance, the user's spend profile may be determined based on their tracked transaction history and the generated performance metrics. User performance may also be determined based on the rate of user's achievement in contests, including the percentage of targets and micro-targets hit within given contests.

In some examples, the contest query 124, responsible for determining the contests displayed to users, is responsive to the user profile 128. Certain contests may be more relevant to particular user profiles compared to others (e.g., contests related to student loans for user profiles indicating the user did not attend a school requiring loans, or that the user has no loans). Thus, the contest query 124 can filter out irrelevant contests based on the user profile 128. Similarly, user performance metrics 110, tracked over time, may allow the contest query 124 to fine tune recommended contests displayed to the user 132. If the user profile 128 indicates the user as highly performing in prior contests, the contest query 124 may retrieve more challenging contests (e.g., those identified with lower rates of users achieving targets) to display to the user for potential selection.

Each user (e.g., user 132 and the set of other users 150) may have a user profile 128. The user profiles can be compared between each user to determine a comparison set 114 of users relative to the user 132. Machine learning generated embeddings, natural language processing, hard coded logic and/or other techniques may be used to generate similarity scores between each user profile in the nudge generation system, or within a given contest. The similarity scores may be compared against a similarity threshold 202 to determine the comparison set 114. Thus, like users can be pooled together for analysis during a given contest.

### Example Comparison Set Illustration

FIG. 3 illustrates an example of an insight determined by evaluating a comparison set according to certain examples. Examples of specific performance metrics 302, 304 are shown related to a first user and a second user. As is shown, each user's transaction histories can be tracked and categorized allowing for comparison between each user's financial habits. The nudge generation system 102 can then identify users to compare performance with (e.g., as within the same contest) to determine and generate insights nudged to the a user as alerts.

In the example of FIG. 3, User Y, defined by transaction history, can represent the first user which the nudge generation system 102 is determining an insight. The nudge generation system 102 can identify User Y as underperforming relative to another, higher performing user such as User X, defined by transaction history. In response, the nudge generation system 102 determines User X as part of the comparison set relative to User Y. The nudge generation system 102 then analyzes the transaction histories according to different performance metrics 302, 304. In the case of FIG. 3, the example performance metrics being analyzed relate to the users'transaction histories relative grocery purchases and comparative spending. The nudge generation system 102 then generates an insight based off the compared performance metrics and transaction histories within the comparison set. As is shown, the example insight 306 can indicate, through an alert pushed to user Y, that user X spent 20% less on groceries compared to user Y with most groceries bought from a Datamart. In a further example, as discussed with respect to FIG. 1, the nudge generation system 102 may then pair with a retail database 118 for further insight generation. In a further illustration according to FIG. 3, the nudge generation system 102 may then retrieve data regarding Datamart from the retail database 118 to provide further insights in addition to insight 306, such as suggesting specific discounts that may help user Y achieve their financial goals.

### Example Method for Displaying Insights to Users

FIG. 4 illustrates an example method of displaying nudges to users, the nudges comprising an insight presented in the form of an alert, according to certain examples. Other examples may include more operations, fewer operations, different operations, or a different order of the operations shown in FIG. 4

At block 401, the nudge generation system 102 displays one or more contests. As described with respect to FIG. 1, the contests can include a range of games designed to motivate users to reach various targets and achieve financial goals. In some examples, the contest query 124 is capable of determining a set of one or more contests from a larger database of contests for display to the user according to the user's profile 132. For instance, the contest query 124, based on a user's profile, may determine that certain contests may be more relevant to a given user, and display the more relevant contests accordingly. For example, a user profile indicating that the user is the head of a household with children may cause the contest query 124 to retrieve for display specific contests related to saving a target amount per month for school expenses such as tuition. In some examples, the contest query 124 can process feedback 136 from users 132, either directly or through processing the rate of selection of a given contest. Some contests, for instance, may be displayed after the contest query 124 determines that such contests include a threshold percentage of users succeeding.

At block 402, the nudge generation system 102 receives from a user 132 a selection of a contest of the one or more contests. In some examples, the user 132 can select multiple contests at a time and can compete simultaneously in the multiple contests. The user 132 having selected a contest can cause the contests module 106 to process the contest selection as feedback, to track the popularity of various contests.

At block 403, the nudge generation system 102 receives a user profile 140 associated with the user. The user profile 140 can be received prior to the user 132 having selected a contest (e.g., in cases where the contest query 124 determines contests 120 to display to the user based on the user profile). The user profile 140, as discussed with respect to FIGS. 1 and 2, can contain various forms of data and user to allow the nudge generation system to 102 to identify users of similar profiles.

At block 404, the nudge generation system 102 identifies a comparison set 114 associated with the selected contest 122 based on the user profile 140 exceeding a threshold similarity when compared to a set of user profiles associated with the comparison set 114. The comparison set 114 can comprise one or more users identified has having a similar user profile to a given user 132. The similarities between comparison set 114 candidates and the given user 132 may be determined by generating a similarity score between the user 132, and each of the one or more other users 150 competing within the selected contest 122. The threshold similarity can be adjusted based on a variety of factors to control the size of the comparison set 114. For instance, with contests with larger user bases, the threshold similarity may be raised from 90% to 95% similarity score to maintain a smaller comparison set 114.

In other examples, the comparison set 114 may comprise the entirety of other users in the selected contest 122, i.e., the contests displayed to each user may be selected by the contest query 124 such that contests 120 are only displayed to users with sufficiently similar user profiles to exceed a given threshold similarity. In such cases, every other user in a contest will comprise the comparison set according to a given user 132.

At block 405, the nudge generation system 102 categorizes one or more user transactions, and for each of the one or more user transactions, tracks a user performance metric 110 associated with the user transaction. Transaction categorization may be performed by a transaction history categorization module 108 by applying machine learning algorithms, natural language processing techniques, hard coded rule based logic, and/or any other software algorithms used for transaction categorization and tracking as is known in the art. Once the transactions are categorized, the nudge generation system 102 can generate performance metrics 110 related to the categorized transactions. Performance metrics 110 can relate to the target of the contest or other metrics capable of providing analysis regarding user behavior. Examples of performance metrics 110 can include the rate of spending in a given category of transaction, the locations, times and dates, of transactions and the like.

At block 406, the nudge generation system 102 categorizes one or more comparison transactions by the comparison set, and for each of the one or more comparison transactions, tracks a comparison performance metric associated with the comparison transaction. Similar to block 305, the nudge generation system can categorize user transactions relying on a transaction history categorization module configured to categorize and log transactions, then generate performance metrics related to the classified transactions.

At block 407, the nudge generation system 102 determines an insight 112. The nudge generation system 102, through the insights module 104 can determine insights by comparing the performance metrics of the user and the comparison set of users. For instance, based on the comparison set of users highly performing in a given contest, identified through their performance metrics, the insights module 104 may determine an insight in the form of a corrective action that can be transmitted to the user 132 to motivate the user to reach a given target in a manner similar to the comparison set 114. Further methods of determining an insight are described with respect to FIG. 5.

At block 408, the nudge generation system 102 displays an alert associated with the insight to the user. The alert 134, displayed to the user 132 including the insight functions as a nudge, where the nudge can further motivate the user to reach the target 146 by the provided insight. Alerts may be transmitted to the user based on behaviors identified by the insights module 104 (e.g., through analysis of the performance metrics). The alerts may be provided periodically or at random intervals to provide continuous motivation to the user

### Example Methods of Determining Insights to Present to Users

FIG. 5 illustrates example methods of determining insights to present to users in the form of alerts according to certain examples. Other examples may include more operations, fewer operations, different operations, or a different order of the operations shown in FIG. 4. Other examples may include more operations, fewer operations, different operations, or a different order of the operations shown in FIG. 5.

At block 501, the nudge generation system 102 determines an insight 112. Block 501 is similar to block 407 of FIG. 4, and further indicates procedures described with respect to blocks 502-503, and 504-506 further describing how the nudge generation system 102 can determine an insight.

At block 502, the nudge generation system 102 determines one or more of the user performance metrics exceeds, by a negative threshold, a corresponding comparison performance metric. The negative performance threshold may represent a threshold difference in user behaviors, as determined by performance metrics 110, between the user 132 and the comparison set 114. The user's performance metrics, falling below the negative performance threshold when compared against the performance metrics of the comparison set, may cause the nudge generation system 102 to further analyze the performance difference as described with respect to block 403. As an example, the comparison set performance metric may indicate that the comparison set 114 has reduced discretionary spending by 50%, and that the user's performance metrics indicate 10% reduction in discretionary spending. The 40% difference in performance between the user and the comparison set may be compared against the negative performance threshold, and if, for instance, the negative performance threshold was 30%, the nudge generation system 102 may proceed to block 403 to determine a corrective action based on the behaviors of the comparison set based on their corresponding performance metrics. In other examples, the negative threshold may refer to a binary split in performance between the user and the comparison set (e.g., the performance metrics of the comparison set indicating the comparison set has hit a micro-target 148, while the user's performance metrics have indicated that they have not).

At block 503, the nudge generation system 102 identifies a corrective action based on a corresponding comparison performance metric. Having determined that the comparison set outperforms the user at block 502, the nudge generation system can analyze the performance metrics of the comparison set to identify the corrective action. The corrective action can include a recommendation to be delivered as part of the insight to help a user reach the contest target 146 or micro-targets 148. In the discretionary spending example, after identifying the comparison set reduced discretionary spending by 50% compared to the user's 30% reduction, the nudge generation system 102 can further analyze the comparison performance metrics, to identify specific types of transactions or transactional patterns in the comparison set, such as identifying that the comparison set reduced spending by cancelling recurring subscriptions. The nudge generation system 102 may then determine cancelling recurring subscriptions as a corrective action which can be delivered to the user as part of the insight.

In some examples, the nudge generation system 102 can monitor user performance in response to receiving insights to determine the effectiveness of the insights such that future insights and nudges can be refined. Blocks 504-506 provide an example set of operations of a process for refining insights and nudges.

At block 504, the nudge generation system 102 tracks one or more user performance and/or comparison performance metrics in response to a previously displayed alert associated with a previous insight. In a personalized, user-specific example, the nudge generation system 102 tracks the user's performance in response to an insight nudged to that specific user by tracking the specific user's performance metrics. As an example, a previous insight nudged to the user identifies a corrective action suggesting the user can achieve a target spending goal by reducing spending on clothing by 50%. Subsequent to the insight being delivered to the user, the system may then monitor the specific performance metric of user clothes shopping. In a more generalized example, the nudge generation system 102 tracks the comparison set's response, or the response of all users who have received a given insight (e.g., a recommendation to reduce clothes spending by 50%), to determine a more global response to the nudge.

At block 505, the nudge generation system 102, the nudge generation system 102 determines an effectiveness of the previous insight. Having monitored and tracked the performance of a user, or group of users such as the comparison set, in response to insights being delivered to the respective user or set of users, the nudge generation system 102 can determine the effectiveness of a given insight. The nudge generation system 102 can determine the effectiveness of the insight personal to a specific user, and/or the effectiveness of the insight of a more general set of users in the competition, or other competitions within the gaming environment. Measuring effectiveness can entail comparing a change in one or more performance metrics in response to the insight being delivered to the user or set of users. For instance, a percent reduction in a given performance metric, such as a reduction in ordering food delivery, may cause the nudge generation system 102 to adjust a relative effectiveness of the insight delivered to the user. Effectiveness, also referred to as an impact value, may be stored as data value on a normalized scale, percentage, Boolean, or the like.

At block 506, the nudge generation system 102 modifies the corrective action based on the effectiveness of the previous insight. The nudge generation system 102 can compare the effectiveness of a given insight against a threshold impact value. For instance, a threshold impact value may indicate that insights that have an effectiveness or impact value of 50% or greater may cause the insights module 104 to not modify the corrective action within the insight prior to transmitting the insight to the user through the alert, but that insights that have an impact value lower than 50% may cause the insights module 104 to retrieve another insight, or to modify the corrective action in the next generated insight. In the food delivery example, if the previous insight nudged to the user recommends to spend less on food delivery to meet the contest target, but the insight was determined only to be 30% effective compared to a threshold impact value requiring 40% effectiveness, the nudge generation system 102 may then modify the corrective action in a subsequent insight provided to the user, for instance where the subsequent insight includes a corrective action identifying specific food delivery deals and discounts which may allow the user to save without nudging the user to order less food delivery. In such a manner, the insights module 104 can fine tune insights provided to users such that progressively over time, the insights module 104 generates insights more personal and more effective to a given user.

### Example Computing System for Providing Personalized Insights in a Competition Environment

Any suitable computing system or group of computing systems can be used for performing the operations described herein. For example, FIG. 6 illustrates a block diagram for an example computing environment capable of executing the described systems and methods, according to certain examples.

The depicted example of a computing system 602 includes one or more processors 606 communicatively coupled to one or more memory devices 604. The processor 606 executes computer-executable program code or accesses information stored in the memory device 604. Examples of processor 606 include a microprocessor, an application-specific integrated circuit (“ASIC”), a field-programmable gate array (“FPGA”), or other suitable processing device. The processor 606 can include any number of processing devices, including one.

The memory device 604 includes any suitable non-transitory computer readable medium for storing the insights module 622, contests clusters 624, chatbot instructions 626 and other received or determined values or data objects. The computer-readable medium can include any electronic, optical, magnetic, or other storage device capable of providing a processor with computer-readable instructions or other program code. Non-limiting examples of a computer-readable medium include a magnetic disk, a memory chip, a ROM, a RAM, an ASIC, optical storage, magnetic tape or other magnetic storage, or any other medium from which a processing device can read instructions. The instructions may include processor-specific instructions generated by a compiler or an interpreter from code written in any suitable computer-programming language, including, for example, C, C++, C#, Visual Basic, Java, Python, Perl, JavaScript, and ActionScript.

The computing system 602 may also include a number of external or internal devices such as input or output devices. For example, the computing system 602 is shown with an input/output (“I/O”) interface 608 that can receive input from input devices or provide output to output devices. A bus 608 can also be included in the computing system 602. The bus 608 can communicatively couple one or more components of the computing system 602.

The computing system 602 executes program code that configures the processor 606 to perform one or more of the operations described above with respect to FIGS. 1-5. The program code includes operations related to, for example, tracking transactions by users, storing the transactions in a transaction database 116, generating performance metrics 110, and determining insights to transmit back to users as alerts 134, or other suitable applications or memory structures that perform one or more operations described herein. The program code may be resident in the memory device 604 or any suitable non-transitory computer-readable medium and may be executed by the processor 606 or any other suitable processor. In some embodiments, the program code described above, the insights module 622, contests clusters 624, chatbot instructions 626 and other received or determined values or data objects are stored in the memory device 604, as depicted in FIG. 6. In additional or alternative embodiments, one or more of the insights module 622, contests clusters 624, chatbot instructions 626, and other received or determined values or data objects and the program code described above are stored in one or more memory devices accessible via a data network, such as a memory device accessible via a cloud service.

The computing system 602 depicted in FIG. 6 also includes at least one network interface 612. The network interface 612 includes any device or group of devices suitable for establishing a wired or wireless data connection to one or more data networks 614 such as viewing applications 620 including user interfaces. Non-limiting examples of the network interface 612 include an Ethernet network adapter, a modem, and/or the like. A remote communication service 618 is connected to the computing system 602 via network 614 and can perform some of the operations described herein including for example, tracking transactions by users, storing the transactions in a transaction database 116, generating performance metrics 110, and determining insights to transmit back to users as alerts 134. The computing system 602 is able to communicate with one or more of the remote communication service 618 and the insights module 622 using the network interface 610. Although FIG. 6 depicts the insights module 622 as connected to computing system 602 via the network 614, other embodiments are possible, including the insights module 622 running as a program in the memory device 604 of computing system 602.

### Advantages of Systems and Methods Providing Personalized Insights in a Competition Environment

The insight system provides for a particular configuration of inputs, including location tracking data associated with users, and behavioral data acquired from the same and other users in order to generate personalized insights and motivation determined to be most effective in assisting users achieve goals and meet targets, providing for improvements in personal finance technologies. For example, the insight system can track user actions and transactions at particular locations to predict future behavior at those locations. The insight system may determine based on previous acts by a user, that the user is likely to commit acts that would prevent them from achieving their identified goals. In response, the insight system can generate an alert to nudge the user when the user returns to the location, providing additional incentives and motivations for the user to refrain from predicted behaviors that would otherwise prevent them from reaching their identified goals.

The configurations of the data sources, including transaction histories of the user and the transaction histories of other users, are also used to provide an improved user interface experience. Compared to traditional personal finance systems, the described insight system is able to further motivate users by providing a competition based interface, wherein the insights system can enroll users in contests, further incentivizing users to reach their goals. The insight system, having arranged users into contests and gamified pools, can provide comparisons, such as leaderboards, and personalized insights and nudges indicating the user's relative success amongst the pool in hitting their targets. By arranging the users into the contests and determining comparison sets of user to compare performance against, the insight system can apply new measurement techniques for generating new forms of data used to identify user trends and corrective actions to assist the users when they are identified as failing to achieve their goals.

### General Considerations

Although the subject matter has been described in language specific to structural features or methodological acts, it is to be understood that the subject matter of the appended claims is not necessarily limited to the specific features or acts described above. Rather, the specific features and acts described above are disclosed as examples.

Various operations of examples are provided herein. The order in which one or more or all of the operations are described should not be construed as to imply that these operations are necessarily order dependent. Alternative ordering will be appreciated based on this description. Further, not all operations may necessarily be present in each example provided herein. Other examples may include more operations, fewer operations, different operations, or a different order of the operations shown in FIGS. 3-4.

As used in this application, “or” is intended to mean an inclusive “or” rather than an exclusive “or.” Further, an inclusive “or” may include any combination thereof (e.g., A, B, or any combination thereof). In addition, “a” and “an” as used in this application are generally construed to mean “one or more” unless specified otherwise or clear from context to be directed to a singular form. Additionally, at least one of A and B and/or the like generally means A or B or both A and B. Further, to the extent that “includes”, “having”, “has,” “with,” or variants thereof are used in either the detailed description or the claims, such terms are intended to be inclusive in a manner similar to the term “comprising”.

Further, unless specified otherwise, “first,” “second,” or the like are not intended to imply a temporal aspect, a spatial aspect, or an ordering. Rather, such terms are merely used as identifiers, names, for features, elements, or items. For example, a first state and a second state generally correspond to state 1 and state 2 or two different or two identical states or the same state. Additionally, “comprising,” “comprises,” “including,” “includes,” or the like generally means comprising or including.

Although the disclosure has been shown and described with respect to one or more implementations, equivalent alterations and modifications will occur based on a reading and understanding of this specification and the drawings. The disclosure includes all such modifications and alterations and is limited only by the scope of the following claims.

What is claimed is:

1. A method comprising:
displaying one or more contests;
receiving, from a user, a selection of a contest of the one or more contests;
receiving a user profile associated with the user;
identifying a comparison set associated with the selected contest based on the user profile exceeding a threshold similarity when compared to a set of user profiles associated with the comparison set;
categorizing one or more user transactions and, for each of the one or more user transactions, tracking a user performance metric associated with the user transaction;
categorizing one or more comparison transactions by the comparison set, and for each of the one or more comparison transactions, tracking a comparison performance metric associated with the comparison transaction;
determining an insight through steps comprising:
determining one or more of the user performance metrics exceeds, by a negative threshold, a corresponding comparison performance metric;
identifying a corrective action based on corresponding comparison performance metric; and
displaying an alert associated with the insight.

2. The method of claim 1, wherein determining the insight further comprises:
tracking the one or more user performance metrics in response to a previously displayed alert associated with a previous insight;
determining an effectiveness of the previous insight; and
modifying the corrective action based on the effectiveness of the previous insight.

3. The method of claim 1, wherein determining the insight further comprises:
tracking the one or more comparison performance metrics in response to a previously displayed alert associated with a previous insight;
determining an effectiveness of the previous insight; and
modifying the corrective action based on the effectiveness of the previous insight.

4. The method of claim 1, wherein determining the insight is based in part on a location of the user.

5. The method of claim 1, wherein the comparison set is not associated with the selected contest, and the one or more comparison transactions by the comparison set are tracked external to the selected contest.

6. The method of claim 1, wherein the user profile is based in part on the user performance metrics.

7. The method of claim 1, wherein the selected contest includes a target and one or more micro-targets, wherein the user performance metrics are further is based on whether the user reaches one of the one or more micro-targets.

8. The method of claim 7, wherein one of the one or more micro-targets are adjusted based on the user performance metrics.

9. The method of claim 1, wherein the alert is displayed via an interface comprising a machine learning trained chat model.

10. The method of claim 1, wherein the one or more contests displayed are determined based on the user profile.

11. A system comprising:
one or more processors configured to:
display one or more contests;
receive, from a user, a selection of a contest of the one or more contests;
receive a user profile associated with the user;
identify a comparison set associated with the selected contest based on the user profile exceeding a threshold similarity when compared to a set of user profiles associated with the comparison set;
categorize one or more user transactions and, for each of the one or more user transactions, tracking a user performance metric associated with the user transaction;
categorize one or more comparison transactions by the comparison set, and for each of the one or more comparison transactions, tracking a comparison performance metric associated with the comparison transaction;
determine an insight through steps comprising:
determining one or more of the user performance metrics exceeds, by a negative threshold, a corresponding comparison performance metric;
identifying a corrective action based on corresponding comparison performance metric; and
display an alert associated with the insight to the user.

12. The system of claim 11, wherein causing the one or more processors to determine an insight based in part on the comparison comprises causing the one or more processors to:
track the one or more user performance metrics in response to a previously displayed alert associated with a previous insight;
determine an effectiveness of the previous insight, and
modify the corrective action based on the effectiveness of the previous insight.

13. The system of claim 11, wherein causing the one or more processors to determine an insight based in part on the comparison comprises causing the one or more processors to:
track the one or more comparison performance metrics in response to a previously displayed alert associated with a previous insight,
determine an effectiveness of the previous insight, and
modify the corrective action based on the effectiveness of the previous insight.

14. The system of claim 11, wherein the one or more processors are further configured to track a location of the user; and determining the insight is based in part on the location.

15. The system of claim 11, wherein the comparison set is not associated with the selected contest, and the one or more comparison transactions by the comparison set are tracked external to the selected contest.

16. The system of claim 11, wherein the user profile is based in part on the user performance metrics.

17. The system of claim 11, wherein the selected contest includes a target and one or more micro-targets, wherein the user performance metrics are further based on whether the user reaches one of the one or more micro-targets.

18. The system of claim 17, wherein one of the one or more micro-targets are adjusted based on the user performance metrics.

19. The system of claim 11, wherein the alert is displayed via an interface comprising a machine learning trained chat model.

20. A non-transitory computer readable medium comprising instructions that, when executed by one or more processors, cause the one or more processors to:
display one or more contests;
receive, from a user, a selection of a contest of the one or more contests;
receive a user profile associated with the user;
identify a comparison set associated with the selected contest based on the user profile exceeding a threshold similarity when compared to a set of user profiles associated with the comparison set;
categorize one or more user transactions and, for each of the one or more user transactions, tracking a user performance metric associated with the user transaction; and
categorize one or more comparison transactions by the comparison set, and for each of the one or more comparison transactions, tracking a comparison performance metric associated with the comparison transaction;
determine an insight through steps comprising:
determining one or more of the user performance metrics exceeds, by a negative threshold, a corresponding comparison performance metric;
identifying a corrective action based on corresponding comparison performance metric; and
display an alert associated with the insight to the user.
